(19) United States
(12) Patent Application Publication
(10) Pub. No.: US 2013/0061877 A1
(43) Pub. Date: Mar. 14, 2013

(54) CLEANING METHOD

(71) Applicants: Emiko NAKAGAWA, Mobara (JP); Setsuo Kobayashi, Mobara (JP); Shinji Tanabe, Mobara (JP)

(72) Inventors: Emiko NAKAGAWA, Mobara (JP); Setsuo Kobayashi, Mobara (JP); Shinji Tanabe, Mobara (JP)

(73) Assignee: Japan Display East Inc.

(21) Appl. No.: 13/609,298

(22) Filed: Sep. 11, 2012

(30) Foreign Application Priority Data
Sep. 12, 2011 (JP) 2011-198329

(51) Int. Cl. B08B 7/00

(52) U.S. Cl. 134/7

(57) ABSTRACT

The present invention relates to a cleaning method using dry ice pellets that make it possible to efficiently peel off a UV resin. The cleaning method according to the present invention is a method for cleaning a surface of an object to be cleaned that is fixed to a fixture by blowing dry ice pellets against the above-described object using dry air. The dry air has a dew point of −60° C. to −80° C. A nozzle for jetting the dry air and the dry ice pellets against the surface of the object is provided, and the distance between the nozzle and the surface of the object is 5 mm to 70 mm. The shape of the nozzle in a cross-section is circular, elliptical or rectangular.

### CROSS-REFERENCE TO RELATED APPLICATION

The present application claims priority over Japanese Patent Application JP2011-198329 filed on Sep. 12, 2011, the contents of which are hereby incorporated into this application by reference.

### BACKGROUND OF THE INVENTION

(1) Field of the Invention

The present invention relates to a cleaning method, and in particular to a cleaning method for cleaning the surface of the members of a liquid crystal display panel after being disassembled by blowing dry ice pellets against them using dry air.

(2) Description of the Related Art

In recent years, hybrid products made of a front panel and a liquid crystal display panel pasted together and hybrid products made of a front panel, a liquid crystal display panel and a touch panel pasted together have been mass produced.

Ultraviolet ray curing resins (hereinafter referred to as UV resins) are mainly used to paste parts to general hybrid products. In the case where these hybrid products are found to be defective as a result of inspection by turning them on or by checking their appearance, the members to which a UV ray adheres are discarded instead of being repaired because UV resins are hardened films and are very difficult to remove.

In the case where a hybrid product made of a front panel and a liquid crystal display panel pasted together is found to be defective as a result of inspection by turning it on or checking its appearance, for example, only the liquid crystal display panel is reused, and presently, the upper polarizing plate of the liquid crystal display panel and the front panel are discarded without being repaired because it is very difficult to remove the UV resins. In addition, the backlight and the upper frame of the liquid crystal display panel deform at the time of disassembly, and therefore are discarded instead of being repaired.

Patent Document 1: Japanese Unexamined Patent Publication 2004-008995

### SUMMARY OF THE INVENTION

As described above, though UV resins are used to paste members to hybrid products, it is difficult to remove the UV resins, and therefore, almost all the members to which a UV resin adheres are discarded.

In addition, the UV resins that have been adhered to the outside of liquid crystal display panels to be repaired are manually cleaned by a worker who uses a cloth or a cotton swab soaked with a solvent from which fiber particles are not easily generated and cleaned carefully so as not to break the product.

Therefore, such problems arise that the amount of discarded members is large and it takes time to clean the parts to which a UV resin has been adhered.

The present invention is provided in order to solve the above-described problems with the prior art, and an object of the present invention is to provide a cleaning method using dry ice pellets, which makes it possible to efficiently peel off UV resins.

The above-described and other objects and novel features of the present invention will be clarified from the descriptions of the present specification and the accompanying drawings.

Typical features of the invention disclosed in the present specification are briefly outlined as follows.

The present invention provides a cleaning method for cleaning an object to be cleaned that is fixed to a fixture, which is characterized in that dry air is used to blow dry ice pellets against a surface of the above-described object to be cleaned so that the surface of the above-described object is cleaned.

In addition, according to the present invention, the above-described dry air has a dew point from −60° C. to −80° C.

Furthermore, according to the present invention, a nozzle for jetting the above-described dry air and the above-described dry ice pellets against the surface of the above-described object to be cleaned is provided, and the distance between the above-described nozzle and the surface of the above-described object to be cleaned is 5 mm to 70 mm.

Moreover, according to the present invention, the above-described nozzle has a circular or elliptical shape in a cross-section, and the above-described nozzle is angled at 30° to 80° relative to the surface of the above-described object to be cleaned.

In addition, according to the present invention, a fixing means for fixing the above-described object to be cleaned to the above-described fixture; and a heating means for heating the surface of the above-described object to be cleaned to a temperature of 20° C. to 80° C. are provided. More preferably, a heating means for heating the surface to a temperature of 40° C. to 80° C. is provided.

Furthermore, according to the present invention, the above-described dry ice pellets have a diameter of 1 mm to 3 mm and a length of 1 mm to 5 mm, more preferably, the length is 1 mm to 3 mm.

Moreover, according to the present invention, the above-described object to be cleaned is any of an upper polarizing plate of a liquid crystal display panel, a touch panel or a front window of a product after being disassembled.

The effects gained by the typical features of the invention disclosed in the present specification are briefly described as follows.

The cleaning method using dry ice pellets according to the present invention makes it possible to efficiently peel off a UV resin.

### BRIEF DESCRIPTION OF THE DRAWINGS

FIG. 1 is a conceptual diagram for illustrating a hybrid product made of a front panel and a liquid crystal display panel pasted together;

FIG. 2 is a conceptual diagram for illustrating a hybrid product made of a front panel, a liquid crystal display panel and a touch panel pasted together;

FIG. 3 is a schematic diagram showing the mechanism for implementing the cleaning method using dry ice pellets according to an embodiment of the present invention;

FIG. 4 is a diagram for illustrating the cleaning method using dry ice pellets according to an embodiment of the present invention;

FIG. 5 is a diagram for illustrating the structure more concretely for implementing the cleaning method using dry ice pellets according to an embodiment of the present invention;

FIG. 6 is a diagram for illustrating the structure more concretely for implementing the cleaning method using dry ice pellets according to another embodiment of the present invention;

FIGS. 7A to 7C are diagrams showing the shape of the nozzle in FIG. 3 in a cross-section; and

FIG. 8 is a diagram for illustrating a conventional method for repairing a liquid crystal display panel.

### DESCRIPTION OF THE EMBODIMENTS

In the following, the embodiments of the present invention are described in detail in reference to the drawings.

Here, throughout all the drawings for illustrating the embodiments, the same symbols are attached to the components having the same functions, and the descriptions thereof are not repeated. In addition, the following embodiments do not limit the interpretations of the scope of the present invention.

[Conventional Liquid Crystal Display Device]

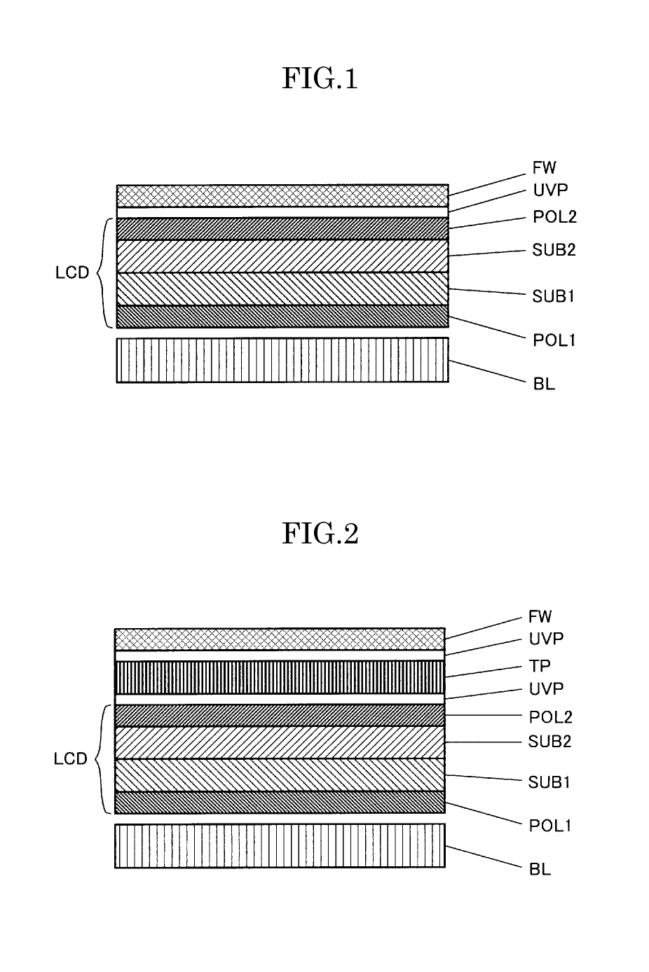

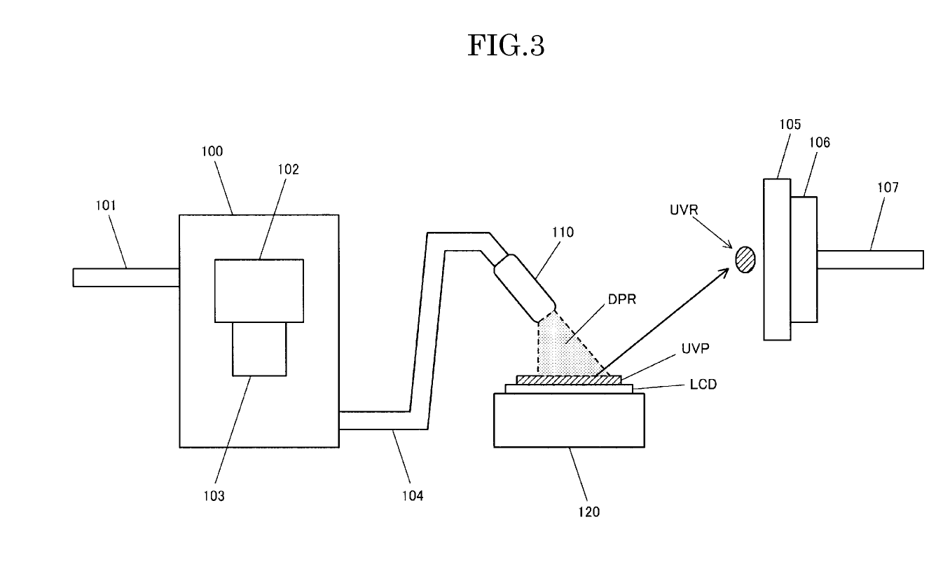

FIG. 1 is a conceptual diagram for illustrating a hybrid product made of a front panel and a liquid crystal display panel pasted together, and FIG. 2 is a conceptual diagram for illustrating a hybrid product made of a front panel, a liquid crystal display panel and a touch panel pasted together.

In FIGS. 1 and 2, FW is a front panel (or front window), LCD is a liquid crystal display panel, TP is a touch panel and BL is a backlight.

The liquid crystal display panel (LCD) has a first substrate (SUB1, glass substrate, for example), a second substrate (SUB2, glass substrate, for example) and a liquid crystal layer (not shown) sandwiched between the first substrate (SUB1) and the second substrate (SUB2). In addition, a lower polarizing plate (POL1) is formed on the first substrate (SUB1) (on the backlight (BL) side), and an upper polarizing plate (POL2) is formed on the second substrate (SUB2) (on the viewer's side).

In FIG. 1, a front panel (FW) is pasted to the top of the upper polarizing plate (POL2) of the liquid crystal display panel (LCD) using an ultraviolet ray curing resin (UVP, hereinafter referred to as UV resin). In FIG. 2, a touch panel (TP) is pasted to the top of the upper polarizing plate (POL2) of the liquid crystal display panel (LCD) using a UV resin (UVP), and at the same time, a front panel (FW) is pasted to the top of the touch panel (TP) using a UV resin (UVP).

Here, scan lines (also referred to as gate lines), counter electrodes (also referred to as common electrodes), an interlayer insulating film, video lines (also referred to as source lines or drain lines), thin film transistors, pixel electrodes and an alignment film are formed on the first substrate (SUB1) on the liquid crystal layer side in this order.

A light blocking film, red, green and blue color filters, a flattening film and an alignment film are formed on the second substrate (SUB2) on the liquid crystal layer side in this order.

The liquid crystal display panel (LCD) is formed by layering the first substrate (SUB1), on which pixel electrodes, thin film transistors and the like are formed, and the second substrate (SUB2), on which color filters and the like are formed, on top of each other with a predetermined distance in between, pasting the two substrates together using a sealing material provided in the peripheral portion of the two substrates in frame form, injecting liquid crystal inside the sealing material between the two substrates through an opening provided in the sealing material so that the liquid crystal is sealed therein, and pasting polarizing plates outside the two substrates.

Here, the counter electrodes can be applied to a TN (twisted nematic) type and a VA (vertically aligned) type liquid crystal display devices. In the case of a TN type or VA type liquid crystal display panel, the counter electrodes are provided on the second substrate side. In the case of an IPS type, they are provided on the first substrate side.

The present invention does not relate to the internal structure of liquid crystal panels, and therefore, a detailed description of the internal structure of the liquid crystal panel is omitted. Furthermore, the present invention can be applied to a liquid crystal panel having any structure.

[Problems with Prior Art]

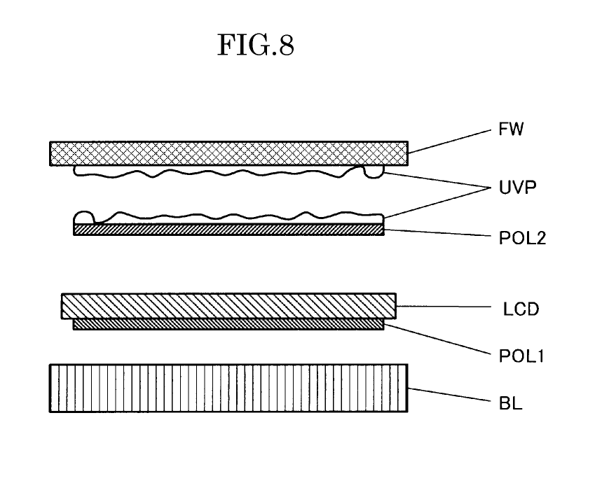

In the case where a hybrid product made of a front panel (FW) and a liquid crystal display panel (LCD) pasted together as in FIG. 1 is found to be defective as a result of inspection by turning it on and by checking its appearance, for example, as shown in FIG. 8, only the liquid crystal display panel (LCD) is reused, and presently, the upper polarizing plate (POL2) and the front panel (FW) are discarded without being repaired because it is very difficult to remove the UV resins. In addition, the backlight (BL) of the liquid crystal display panel deforms when disassembled, and therefore is discarded without being repaired.

Furthermore, the UV resins (UVP) that have been adhered to the outside of liquid crystal display panels (LCD) to be repaired are manually cleaned by a worker who uses a cloth or a cotton swab soaked with a solvent from which fiber particles are not easily generated and cleaned carefully so as not to break the product.

Therefore, such problems arise that the amount of discarded members is large and it takes time to clean the parts of the liquid crystal display panel (LCD) to be repaired to which a UV resin (UVP) has been adhered.

### [Features of the Present Invention]

The present embodiment is characterized in that, in the case where the hybrid product made of a front panel (FW) and a liquid crystal display panel (LCD) pasted together as in FIG. 1 is found to be defective as a result of an inspection by turning it on and by checking its appearance, for example, the UV resin (UVP) for pasting the front panel (FW) and the liquid crystal display panel (LCD) together is broken along the adhesion surface, and then the UV resin (UVP) remaining on the upper polarizing plate (POL2) of the liquid crystal display panel (LCD) and on the adhesion surface of the front panel (FW) is removed using dry ice pellets.

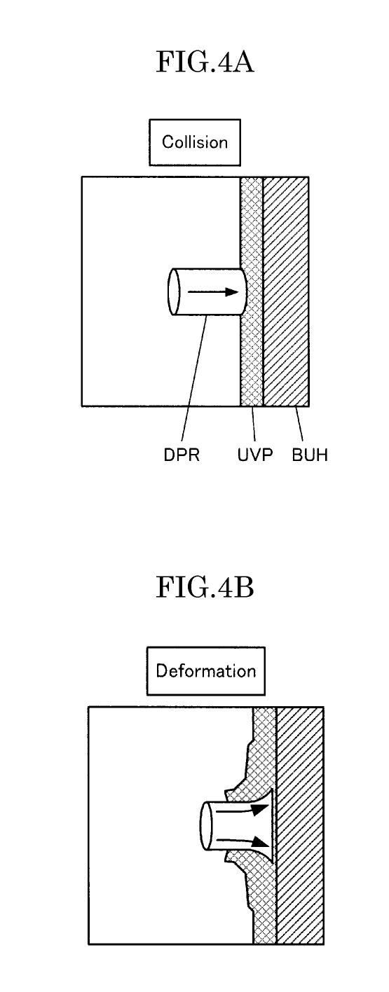

FIG. 3 is a schematic diagram showing the mechanism for illustrating the cleaning method using dry ice pellets according to the embodiment of the present invention.

In FIG. 3, 100 is a dry ice blasting apparatus, and dry air is supplied to this dry ice blasting apparatus 100 through a dry air pipe 101. In addition, a preset amount of dry ice pellets that have been put into the dry ice blasting apparatus 100 through a dry ice inlet 102 is fed into the dry ice blasting apparatus 100 by means of an input amount limiting apparatus 103.

The dry ice blasting apparatus 100 adjusts the airflow volume of the dry air and outputs the dry ice pellets and the dry air to a pressurized hose 104 so that a nozzle 110 blows the dry ice pellets and the dry air against an object to be cleaned (liquid crystal display panel (LCD) in FIG. 3, in the following, simply referred to as object) that has been fixed to a fixture 120. As a result, the UV resin (UVP) remaining on the liquid crystal display panel (LCD) is removed.

The removed UV resin (UVR) is suctioned through an air duct 105 together with the air that is suctioned through an air duct pipe 107 and is captured by a filter 106.

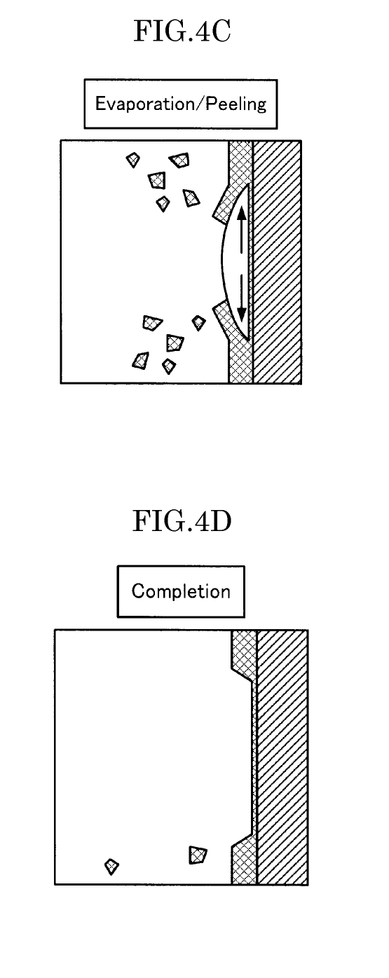

FIG. 4 is a diagram for illustrating the cleaning method according to an embodiment of the present invention. In the following, the cleaning method according to the present embodiment is described in reference to FIG. 4.

First, the nozzle 110 provided at the tip of the pressurized hose 104 of the dry ice blasting apparatus 100 accelerates dry ice pellets (DPR) by means of dry air so that the dry ice pellets (DPR) are jetted against the surface of an object (BUH) (see FIG. 4(a)).

As a result, the dry ice pellets (DPR) enter into the UV resin (UVP) that has been adhered to the surface of the object (BUH) (see FIG. 4(b)). At this time, the UV resin (UVP) is quickly cooled, and this difference in temperature that is quickly created has an effect of peeling off the UV resin (UVP), which is an extraneous matter.

The hardness of the dry ice pellets (DPR) is two or less according to Mohs scale, and therefore, the dry ice pellets (DPR) spread laterally when colliding with the surface of the object (BUH) so as to enter between the UV resin (UVP) and the object (BUH) and quickly evaporate so that the volume thereof expands. This change in the volume spreads the space in between so that the UV resin (UVP) is blown off (see FIG. 4(c)).

The dry ice pellets (DPR) that have been jetted from the nozzle 110 are instantly sublimated into carbon dioxide, and therefore, there is no residue (see FIG. 4(d)).

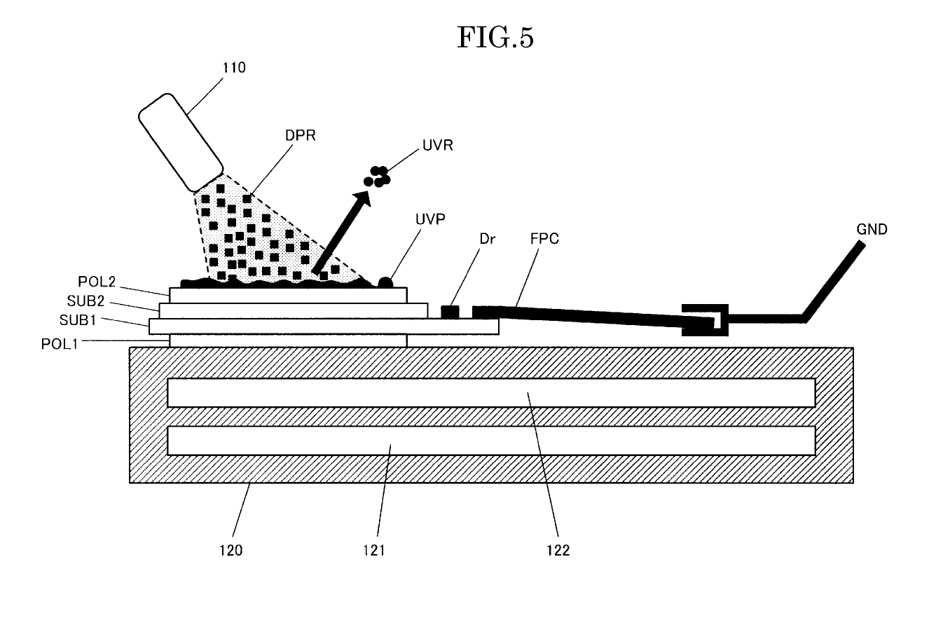

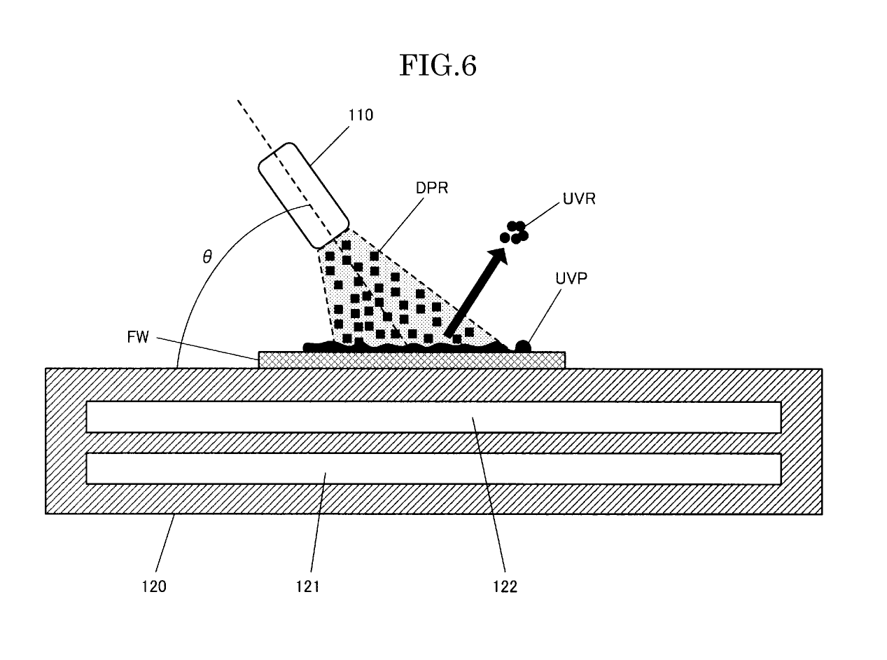

FIGS. 5 and 6 are diagrams for illustrating the structures more concretely for implementing the cleaning method using dry ice pellets according to the embodiments of the present invention.

FIGS. 5 and 6 are diagrams for illustrating how the UV resin (UVP) remaining on the adhesion surface of the upper polarizing plate (POL2) of the liquid crystal display panel (LCD) is removed by blowing dry ice pellets (DPR) against it (FIG. 5) and how the UV resin (UVP) remaining on the adhesion surface of the front panel (FW) is removed by blowing dry ice pellets (DPR) against it (FIG. 6) after the UV resin (UVP) for pasting the front panel (FW) and the liquid crystal display panel (LCD) together is broken along the adhesion surface in the case where a hybrid product made of a front panel (FW) and a liquid crystal display panel (LCD) pasted together is found to be defective as a result of an inspection by turning it on and by checking its appearance.

In FIGS. 5 and 6, 120 is a fixture, and this fixture 120 has a heating mechanism 121 for heating an object (liquid crystal display panel (LCD) in FIG. 5) for the sake of preventing dew from being formed on the surface that is to make contact with the dry ice pellets, and a suction mechanism (vacuum suction mechanism, for example) 122 for fixing an object so that the object is not blown off when the surface of the object is jetted with dry ice pellets (DPR) that have been accelerated by the dry air.

In FIG. 5, the dry ice blasting apparatus 100 adjusts the airflow volume of the dry air and the amount of dry ice pellets (DPR), outputs dry ice pellets (DPR) and dry air to the pressurized hose 104, and blows the dry ice pellets (DPR) and the dry air against the upper polarizing plate (POL2) of the liquid crystal display panel (LCD) fixed on the fixture 120 through the nozzle 110, and as a result, the UV resin (UVP) remaining on the upper polarizing plate (POL2) of the liquid crystal display panel (LCD) is removed. Here, in FIG. 5, in order to prevent the liquid crystal display panel (LCD) from being broken due to the charging up through friction from the dry ice pellets (DPR), the terminal portion of a flexible printed circuit (FPC), which is electrically and mechanically fixed to one side of the first substrate (SUB1) and where display data, control signals and the like are inputted into the driver, is connected to the ground potential (GND) so that the charge always flows to the ground potential (GND).

In FIG. 6, the dry ice blasting apparatus 100 adjusts the airflow volume of the dry air and the amount of dry ice pellets (DPR), outputs dry ice pellets (DPR) and dry air to the pressurized hose 104, and blows the dry ice pellets (DPR) and the dry air against the front panel (FW) fixed on the fixture 120 through the nozzle 110, and as a result, the UV resin (UVP) remaining on the front panel (FW) is removed.

As described above, in FIGS. 5 and 6, the use of dry ice pellets (DPR) makes it possible to efficiently peel off the UV resin (UVP) without scratching the upper polarizing plate (POL2) of the liquid crystal display panel (LCD) and the surface of the front panel (FW) or without forming dew.

In the following, the conditions for the cleaning method using dry ice pellets according to the embodiments of the present invention are described.

### (1) Shape of Nozzle 110 in Cross-Section

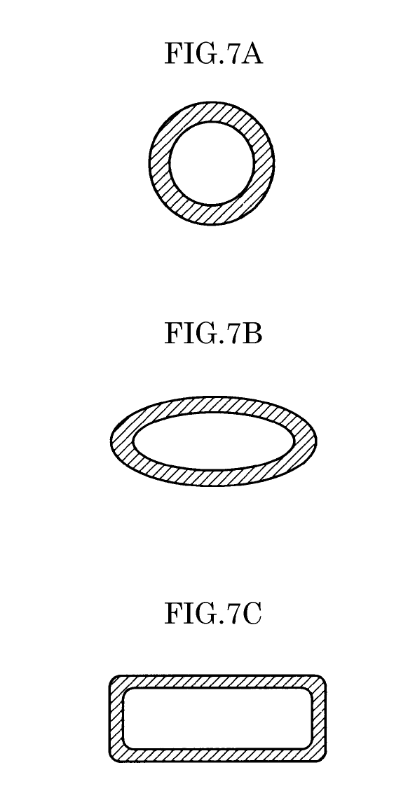

In the case where the shape of the nozzle 110 in a cross-section is circular as shown in FIG. 7(a), the method is effective in removing the UV resin from the periphery portions and microscopic parts or pointed portions. In the case where the shape of the nozzle 110 is elliptical or rectangular as shown in FIGS. 7(b) and 7(c), the method is effective in removing the UV resin from a broad area so that the number of times the nozzle 110 reciprocates can be reduced, making the removal of the UV resin in a short period of time possible.

### (2) Distance Between the Nozzle 110 and the Object

As for the distance between the nozzle 110 and the object to be cleaned, 5 mm to 70 mm is optimal. In the case where the distance between the nozzle 110 and the object is 5 mm or less, there is a risk that the surface of the object may be scratched or the pattern printed on the surface of the object may be peeled off. Furthermore, there are such defects that dew may be formed due to the lowering of the temperature on the surface of the object or the efficiency in removing the UV resin may be poor because the area from which the UV resin is removed using dry ice pellets (DPR) is small.

Moreover, in the case where the distance between the nozzle 110 and the object is 70 mm or more, the impact of the collision of dry ice pellets (DPR) is weak, and thus, there is such a defect that the efficiency in removing the UV resin is low.

### (3) Angle of the Nozzle 110 (θ in FIG. 6)

It is necessary to determine an appropriate angle of the nozzle 110 depending on the location and the area of the extraneous matter to be removed. The angle of the nozzle 110 that is perpendicular)(90°) to the surface of the object is defective because the dry ice pellets (DPR) that have been jetted from the nozzle 110 and collided with the surface of the object may be diffused. In the case where the angle of the nozzle 110 is small, the angle at which the dry ice pellets (DPR) make contact with the surface of the object is small, which is defective because the efficiency in removing the UV resin is low. Therefore, as for the angle of the nozzle 110, 30° to 80° is optimal.

### (4) Heating Temperature

It is necessary to keep the temperature on the surface of the object at 20° C. to 80° C. at the lowest so that no dew is formed on the surface of the subject (the surface from which the UV resin (UVP) is to be removed in FIGS. 5 and 6).

Therefore, a heating mechanism 121 is provided to the fixture 120 in FIGS. 5 and 6, but it is also possible to heat the object from the front surface side. Heating may be possible by directly heating the surface of the subject with warm wind, heating may be possible by directly applying light to the surface of the subject (infrared lamp or fluorescent lamp), or heating may be possible by increasing the temperature of the entirety of the air around the object by means of an air conditioner or a heater (air heating).

### (5) Dew Point of Dry Air

Dry air having a dew point of −60° C. to −80° C. is optimal. The temperature at which dry ice sublimates is −79° C., and therefore, water included in the dry air forms dew when the dry ice pellets (DPR) are jetted from the nozzle 110 in the case where the dew point is high. The thus-formed dew lowers the cleaning efficiency.

### (6) Form of Dry Ice Pellets (DPR)

As for the diameter of the dry ice pellets (DPR), 1 mm to 3 mm is appropriate. In the case where the diameter of the dry ice pellets (DPR) is 1 mm or less, the surface area of the dry ice pellets (DPR) is small, which is defective because the efficiency in removing the UV resin is low.

In the case where the diameter of the dry ice pellets (DPR) is 3 mm or more, the surface area of the dry ice pellets (DPR) is large, which makes the area of contact at the time of blasting large, and thus, the UV resin tends to be removed inconsistently.

It is preferable for the length of the dry ice pellets (DPR) to be 1 mm to 5 mm, and it is more preferable for it to be 1 mm to 3 mm.

Though in the above the cleaning method using dry ice pellets according to the present invention is described by citing an embodiment where it is applied to the method for repairing a hybrid product made of a front panel (FW) and a liquid crystal display panel (LCD) pasted together, the present invention is not limited to this and can be applied to a method for repairing a hybrid product made of a front panel (FW), a touch panel (T/P) and a liquid crystal display panel (LCD) pasted together.

In this case, it is necessary to remove the UV resin (UVP) remaining on the two surfaces of the touch panel (T/P) in addition to the UV resin (UVP) remaining on the upper polarizing plate (POL2) of the liquid crystal display panel (LCD) shown in FIG. 5 and the UV resin (UVP) remaining on the front panel (FW) shown in FIG. 6 in accordance with the cleaning method using dry ice pellets according to the present invention.

The cleaning method using dry ice pellets according to the present invention is also applicable to the cleaning of the following parts of a liquid crystal display panel (LCD).
(1) A glass substrate to be used as a substrate of a liquid crystal display panel (LCD), from the surface of which a foreign matter, residue after cleaning and other blemishes are to be removed.
(2) A polarizing plate (POL1 or POL2) of a liquid crystal display panel (LCD), from which an adhesive is to be removed.
(3) A touch panel (T/P), from which an adhesive is to be removed.
(4) Markings (printed characters) on a liquid crystal display panel (LCD) or a touch panel (T/P), from the surface of which blemishes are to be removed.
(5) A conductive tape used in a liquid crystal display panel (LCD), from the surface of which blemishes and an adhesive are to be removed.

Furthermore, the cleaning method using dry ice pellets according to the present invention can be applied to the following cleaning in the manufacturing process for a liquid crystal display panel (LCD).
(6) An alignment film, color filter films, an ITO film, a sealing material, an insulating layer and spacers in a liquid crystal display panel (LCD), the surface of which is to be cleaned.

Though the invention made by the present inventor is concretely described on the basis of the above embodiments, the present invention is not limited to the above-described embodiments, and various modifications are naturally possible as long as the gist of the invention is not deviated from.

What is claimed is:

1. A cleaning method for cleaning an object to be cleaned that is fixed to a fixture, characterized in that
dry air is used to blow dry ice pellets against a surface of said object to be cleaned so that the surface of said object is cleaned.

2. The cleaning method according to claim 1, characterized in that said dry air has a dew point from −60° C. to −80° C.

3. The cleaning method according to claim 1, characterized in that
a nozzle for jetting said dry air and said dry ice pellets against the surface of said object to be cleaned is provided, and
a distance between said nozzle and the surface of said object to be cleaned is 5 mm to 70 mm.

4. The cleaning method according to claim 1, characterized in that
a nozzle for spraying said dry air and said dry ice pellets against the surface of said object to be cleaned is provided, and
said nozzle has a circular or elliptical shape in a cross-section.

5. The cleaning method according to claim 1, characterized in that
a nozzle for spraying said dry air and said dry ice pellets against the surface of said object to be cleaned is provided, and
said nozzle is angled at 30° to 80° relative to the surface of said object to be cleaned.

6. The cleaning method according to claim 1, characterized by comprising:
a fixing means for fixing said object to be cleaned to said fixture; and
a heating means for heating the surface of said object to be cleaned to a temperature of 20° C. to 80° C.

7. The cleaning method according to claim 1, characterized in that said dry ice pellets have a diameter of 1 mm to 3 mm and a length of 1 mm to 5 mm.

8. The cleaning method according to claim 7, characterized in that said dry ice pellets have a length of 1 mm to 3 mm.

9. The cleaning method according to claim 1, characterized in that said object to be cleaned is any of an upper polarizing plate of a liquid crystal display panel, a touch panel or a front window of a product after being disassembled.
